(19) United States
(12) Patent Application Publication
(10) Pub. No.: US 2007/0011438 A1
(43) Pub. Date: Jan. 11, 2007

(54) Microprocessor

(75) Inventor: Takanori Tamai, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/243,081

(22) Filed: Oct. 5, 2005

(30) Foreign Application Priority Data
Jul. 11, 2005 (JP) 2005-202179

(51) Int. Cl. G06F 9/40

(52) U.S. Cl. 712/205

(57) ABSTRACT

The microprocessor is simply structured, shortening the time for design and verification, and protecting tasks while executing multiple tasks The microprocessor includes an instruction fetch unit having a request queue configured to issue, to a bus interface unit, a bus request due to an instruction fetch and retain, of instruction fetch requests output to the bus interface unit, unprocessed requests. The microprocessor also includes a load/store unit configured to issue a bus request emanating from a load or a store instruction to the bus interface unit; a decode unit configured to decode an instruction from the instruction fetch unit; an execution unit configured to execute an instruction from the decode unit; and an OR gate configured to make an output signal active and output it to the instruction fetch unit when any one of signals from the decode unit, the execution unit, and the load/store unit becomes active.

### CROSS REFERENCE TO RELATED APPLICATIONS AND INCORPORATION BY REFERENCE

This application is based upon and claims the benefit of priority from prior Japanese Patent Application P2005-202179 filed on Jul. 11, 2005; the entire contents of which are incorporated by reference herein.

### BACKGROUND OF THE INVENTION

1. Field of the Invention

The present invention relates to a microprocessor. It particularly relates to a microprocessor capable of protecting tasks that do not cause a bus error while executing multiple tasks using a small circuit scale bus.

2. Description of the Related Art

In recent years, only instructions that can be executed by a small and simple circuit have been implemented in microprocessors, and program execution duration has been shortened by dividing processing into multiple stages, independent from one another, and then carrying out those stages in parallel. Calculation instructions, load/store instructions or related instructions can be relatively easily implemented in such manner. However, execution of some control instructions for a microprocessor requires the entire operation of the microprocessor to halt, bringing about complex processing and difficulty in dividing and assigning processing to pipeline stages.

Conventionally, to implement a control instruction, a large circuit and a complex control operation have been provided, by either dividing and assigning processing to pipeline stages, or by dividing and separating processing from the pipeline. When dividing and assigning processing to pipeline stages, problems of an increase in power consumption and/or incorporation of defective circuits, due to circuit complexity, may develop. On the other hand, when dividing and separating processing from the pipeline, performance of the microprocessor deteriorates due to insufficient correlation between instructions.

Moreover, according to conventional microprocessors, when determining whether or not execution of an instruction that has entered the pipeline is possible in the present status of the pipeline or the entire microprocessor status, the operation in that stage needs to be the same as that in the stage in which the determination has started, so as to obtain the determination results. This is because, if it is determined that execution is impossible, the operation in that stage is frozen until the instruction is executable and execution is restarted.

According to such an implementation method, when the duration between the beginning of the stage to determine whether or not an instruction is executable and a time at which the determination results are provided becomes longer than the time for execution in other stages, processing duration of a circuit for determining whether or not the instruction is executable specifies an operating frequency for the entire microprocessor.

In recent years, a demand for integrating multiple microprocessors into a single chip has increased, and accordingly, the circuit for determining whether or not an instruction is executable tends to be more complex and operate at a lower speed, which is a problem.

There are many implementation methods for handling bus errors that occur in the bus connected to the microprocessor. As a simple implementation method in which only a bus error signal (BEC: BUS_ERROR_CAUSED) indicating a bus error is provided. There are two ways for asserting the bus error signal: BEC: cycle-synchronous assertion and asynchronous assertion.

The cycle-synchronous assertion allows identification of the bus request that caused the bus error. The identification is possible because an assertion position of a bus error signal BEC is specified, based on a predetermined protocol. The cycle-synchronous assertion may cause an increase in the scale of a circuit operating in conformity with the protocol. The increased circuit scale emanates from the fact that bus errors generally occur at a variety of timings, due to a variety of reasons, and thus, a memory circuit storing the relationship between the cause of the bus error and a corresponding causal bus request is additionally required. To avoid such increase in the scale of the memory circuit, an implementation method is provided in which other bus requests are not accepted during cycles in which a bus error may occur. However, since transfer capability of the bus decreases, that method is not generally used.

On the other hand, the asynchronous assertion is conducted by asserting the bus error signal BEC immediately after occurrence of a bus error, based on a slight relaxation of the protocol of the bus error signal BEC. This procedure omits circuits that perform processing that is relevant to the cause of the bus error, thereby allowing easy implementation method of the asynchronous assertion. In contrast, there is a shortcoming in that identifying which bus request caused the bus error that permits processing of multiple requests is difficult.

Next, a bus that permits processing of multiple bus requests, so as to increase transfer efficiency, is described. When using such a bus, which allows processing of multiple bus requests, for asynchronous assertion of a bus error, identifying the cause of the bus error is impossible, and thus all requests issued to the bus must be discarded. At this time, bus requests that were not the cause of the bus error are sacrificed and discarded. Therefore, a re-processing circuit for re-processing discarded requests has conventionally been added to the bus so as to perform re-processing of the sacrificed and discarded bus requests.

Bus requests of the microprocessor are categorized into a group of requests for instruction fetching and a group of requests for load/store instructions. Even when events such as a bus error occur, the microprocessor needs to carry out restoration whenever possible. Accordingly, restoration of instructions needs to be carried out when the bus requests for a fetch instruction are sacrificed and discarded.

In contrast, when a bus error occurs due to at least one of the bus requests for load/store instructions, execution of the program can no longer be assured. As such, processing according to the program is discarded. Therefore, the bus requests for load/store instructions are all discarded, and need not be re-processed.

In the case where a re-transfer mechanism of operation, implemented to the bus, is incapable of distinguishing bus requests for instruction fetch from bus requests for load/store instructions, the microprocessor ends up unnecessarily re-processing bus requests that do not need to be re-processed.

A decrease in processing performance due to such useless re-processing may not be a problem for the microprocessor. However, such useless re-processing requires more time for cause analysis for development of microprocessors and programs.

Moreover, microprocessors configured to even discard fetch requests are available. This, however, depends on the structure of the microprocessors. In general, when a bus error occurs, ‘exception handling’ is carried out.

Some microprocessors are configured to carry out exception handling only for ‘existing instructions’. With such configuration, when a ‘fetch request’ is sacrificed, thereby halting corresponding processing, exception handling cannot start. Accordingly, at least the fetch request needs to be re-processed.

When a bus error has occurred during an instruction fetch operation by the microprocessor, the fetched data is false. If the microprocessor misreads the data as a normal instruction and accordingly executes it, it may execute a non-implemented instruction because the data is false. At this time, even if a mistaken execution is conducted, it may not prove to be a problem as long as the microprocessor does not stop its operation. Therefore, in the microprocessor design stage, there is a need to ensure verification that execution of such a mistaken instruction will never cause the microprocessor to stop.

In general, such verification is costly because verifying that execution of all sequences of undefined instructions or inhibited instructions never creates a problem is needed.

A countermeasure against such a problem is to not execute mistaken instructions whenever possible. Conventionally, a countermeasure is taken against occurrence of a bus error, such as resetting arrived data at the microprocessor to 0. An instruction code 0 (zero) is generally often defined as a no-operation instruction (NOP), and such countermeasure has been taken. Such countermeasure requires the bus or some sections connected to the microprocessor to have a circuit configured to clear data to 0 (zero).

Another countermeasure is to generate an interruption when a bus error occurs. Generation of an interruption before the core of the microprocessor executes false data allows the microprocessor to discard corresponding instruction. For example, a non-maskable interrupt (NMI), which is a type of interruption the microprocessor cannot reject, may be issued when a bus error occurs.

This method, however, brings about a problem that the microprocessor cannot be in a state in which the microprocessor never accepts any type of interruption, and also that implementation of instructions that do not generate an interruption is impossible.

A bus access error processing method in which the CPU sets a value indicating an occurrence of a bus error to a predetermined flag upon receipt of a bus error signal, allowing the user program to take a counter-action for avoiding a bus access error, has been disclosed (e.g., see Japanese Patent Gazette No. 3177794).

A known bus allows processing of multiple requests. However, all issued requests are discarded and re-requesting is not carried out when a single request has caused a bus error. In the case where such a bus is connected to the microprocessor and bus requests are simultaneously issued due to an instruction fetch and a load/store instruction, respectively, the bus request for an instruction fetch is also discarded when the bus request for a load/store instruction has caused a bus error. Moreover, re-requesting of an instruction fetch is never conducted when the instruction fetch request is not the cause of a bus error.

### SUMMARY OF THE INVENTION

An aspect of the present invention inheres in a microprocessor, which is connectable to an external bus including a bus interface unit and a bus device. The microprocessor includes an instruction fetch unit comprising a request queue that issues, to the bus interface unit, a bus request due to an instruction fetch and that is stored with an unprocessed request of issued instruction fetch requests and output to the bus interface unit. A load/store unit is configured to issue, to the bus interface unit, a bus request due to a load instruction or a store instruction. A decode unit is configured to decode an instruction from the instruction fetch unit. An execution unit is configured to execute an instruction from the decode unit; and an OR gate configured to output an active pipeline-busy signal when at least one of respective signals from the decode unit, the execution unit, and the load/store unit becomes active.

Another aspect of the present invention inheres in a microprocessor, which is connectable to an external bus including a bus interface unit and a bus device. The instruction fetch unit includes a request queue configured to issue a bus request, due to an instruction fetch, to the bus interface unit and retain a task number for identifying a task in which a bus request is being processed and a corresponding bus request. A load/store unit is configured to issue a bus request due to a load instruction or a store instruction to the bus interface unit and includes a memory configured to retain a task number for identifying a task in which a bus request is being processed and corresponding bus request. A decode unit configured to decode an instruction from the instruction fetch unit. An execution unit is configured to execute an instruction from the decode unit. A serialization control unit includes a state retry unit configured to set ‘1’ to the state retry count in the state retry unit and enter a re-processing mode when the state retry unit receives input signals from the instruction fetch unit, the load/store unit, the bus interface unit, and the bus device and a bus error signal from the bus device becomes active, and output suppression signals for suppressing issuance of a bus request from the instruction fetch unit and the load/store unit when a bus interface signal from the bus interface unit is active in the re-processing mode.

### BRIEF DESCRIPTION OF DRAWINGS

FIG. 1 is a schematic block diagram of a microprocessor according to a first embodiment of the present invention;

FIG. 2 is a timing chart showing an operation of a bus interface unit in the microprocessor according to the first embodiment of the present invention when no bus error occurs;

FIG. 3 is a timing chart showing an operation of the bus interface unit in the microprocessor according to the first embodiment of the present invention when a bus error occurs in a clock cycle C3 shown in FIG. 2;

FIG. 4 is a schematic block diagram showing the internal structures of a decode unit 1 and an instruction fetch unit 16 in the microprocessor according to the first embodiment of the present invention;

FIG. 5 is a schematic block diagram of a microprocessor according to a second embodiment of the present invention;

FIG. 6A schematically shows exemplary bus requests stored in a request queue of an instruction fetch unit of the microprocessor according to the second embodiment of the present invention, wherein the bus requests are made to a bus interface unit in a decreasing order of queue number;

FIG. 6B schematically shows exemplary bus requests fetch0, fetch1, fetch2, . . . stored in the request queue of the instruction fetch unit of the microprocessor according to the second embodiment of the present invention, wherein the bus requests are required for instruction fetch for respective stored tasks corresponding to task identification numbers of tasks Task0, Task1, Task2, . . . being executed by the microprocessor;

FIG. 7A schematically shows exemplary bus requests stored in memory of a load/store unit of the microprocessor according to the second embodiment of the present invention, wherein the bus requests are made to the bus interface unit in a decreasing order of queue number;

FIG. 7B schematically shows exemplary bus requests read0, read1, . . . , write0, write1, . . . stored in the memory of the load/store unit of the microprocessor according to the second embodiment of the present invention, wherein the bus requests are made due to load instructions or store instructions that are executed in respective-tasks and are stored corresponding to task identification numbers of tasks Task0, Task1, Task2, . . . being executed by the microprocessor;

FIG. 8 is a timing chart showing an operation of the bus interface unit in the microprocessor according to the second embodiment of the present invention when no bus error occurs; and

FIG. 9 is a timing chart showing an operation of the bus interface unit in the microprocessor according to the second embodiment of the present invention when a bus error occurs in a clock cycle C3 shown in FIG. 8.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

Embodiments according to the present invention are described forthwith while referencing the appended drawings. In the following description, the same or similar reference numerals are attached to the respective same or similar parts. Note that the drawings are schematically illustrated and dimensions of: each block, timing widths in each timing chart, each task, and the width of each type of instruction format may be different from real widths of the present invention. Moreover, needless to say, there may be parts included among the drawings that are illustrated in different dimensions or different ratios.

Moreover, the following embodiments exemplify apparatuses and methods embodying the technical ideas of the present invention, which are not limited to parts and arrangement of each block described below. The technical ideas of the present invention allow a variety of modifications within the scope of the appended claims.

### First Embodiment

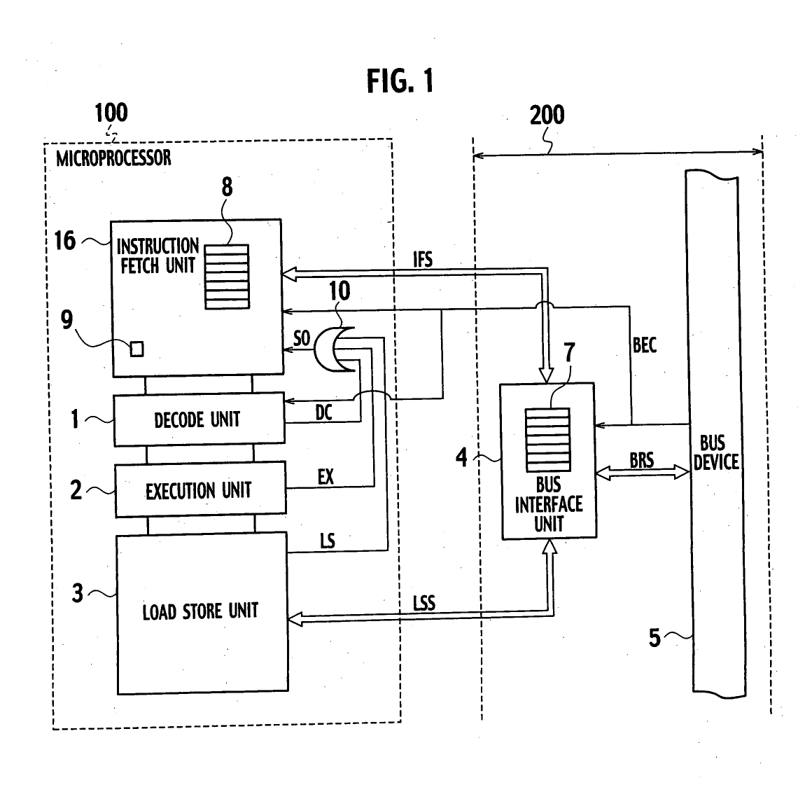

As shown in FIG. 1, a microprocessor 100 according to the first embodiment of the present invention is connectable to an external bus 200, which includes a bus interface unit (BIU) 4 and a bus (BUS) device 5. The microprocessor 100 includes an instruction fetch unit (IFU) 16 having a first request queue 8 that issues a bus request for an instruction fetch to the bus interface unit 4 and stores unprocessed requests of the instruction fetch requests issued to the bus interface unit 4, a load/store unit (LSU) 3 configured to request a bus request for a load instruction or a store instruction to the bus interface unit 4, a decode unit (DCU) 1 configured to decode an instruction from the instruction fetch unit 16, an execution unit (EXU) 2 configured to execute an instruction from the decode unit 1, and an OR gate (ORU) 10 configured to generate an active output signal SO and then send the active output signal to the instruction fetch unit 16 when at least one of input signal, such as a signal DC from the decode unit 1, a signal EX from the execution unit 2, or a signal LS from the load/store unit 3, becomes active.

Alternatively, as shown in FIG. 1, the instruction fetch unit 16 may comprise a first state retry unit 9 configured to retain information that a request existing in the first request queue 8 has again been output to the bus interface unit 4 and that re-requesting of an instruction fetch is carried out.

Alternatively, as shown in FIG. 1, the decode unit 1 is configured to convert instruction codes issued from the instruction fetch unit 16 to a NOP instruction when a bus error occurs when a state retry count in the first state retry unit 9 is ‘1’.

According to the first embodiment of the present invention, the combination of the bus device 5 and the bus interface unit 4 is defined as the external bus 200. The combination of the instruction fetch unit 16, the decode unit 1, the execution unit 2, the load/store unit 3, and the OR gate 10 is defined as the microprocessor 100.

A bus error signal BEC is implemented to indicate an asynchronous assertion of a bus error. The Bus device 5 is used to transfer data. If a bus error occurs, the bus error signal BEC is activated.

The instruction fetch unit 16 in the microprocessor 100 issues a bus request for an instruction fetch to the bus interface unit 4 via a bus request signal IFS.

The load/store unit 3 of microprocessor 100 issues a bus request to the bus interface unit 4 via the bus request signal LSS, due to a load instruction or a store instruction.

The bus interface unit 4 receives and transmits a bus request issued from the microprocessor 100 from/to the Bus device 5 via a bus request signal BRS. The bus interface unit 4 includes a processing queue 7 configured to store a request from the microprocessor 100. When the bus error signal BEC is active, the bus interface unit 4 interprets the active signal as indeterminate data having been read out and then terminates the bus request from the processing queue 7. ‘Terminate’ means to close the session with a bus request source, based on a predetermined protocol. When the bus request is a read-out request, the indeterminate data is returned to the source, closing the session based on the predetermined protocol.

The decode unit 1 decodes instructions for the microprocessor 100. When the decode unit 1 includes an instruction to be executed, a decode signal DC is activated.

The execution unit 2 executes instructions for the microprocessor 100. When the execution unit 2 includes an instruction to be executed, an execution signal EX is activated.

The load/store unit 3 receives and transmits a bus request for load instructions or store instructions from/to the bus interface unit 4 via the bus request signal LSS. When the load/store unit 3 retains a bus request to be received or transmitted from/to the bus interface unit 4, the load/store signal LS is activated.

The OR gate 10 activates an output signal SO when at least one of the signals: the decode signal DC, the execution signal EX, or the load/store signal LS is activated. An active output signal SO means that the microprocessor 100 retains an instruction to be executed.

The instruction fetch unit 16 of the microprocessor 100 manages an instruction fetch request. The instruction fetch unit 16 transfers an instruction fetch request to the bus interface unit 4 for an instruction to be executed by the microprocessor 100. Moreover, the instruction fetch unit 16 includes a first request queue 8 configured to store requests for which request results are not yet provided (unprocessed requests) out of the instruction fetch requests issued to the bus interface unit 4.

The instruction fetch unit 16 is capable of re-issuing a request existing in the request queue to the bus interface unit 4. This action is referred to as ‘re-issuance of an instruction fetch request’. The instruction fetch unit 16 includes the first state retry (STATE_RETRY) unit 9 configured to retain information that an instruction fetch request has been re-issued. Once the instruction fetch request is re-issued, a state retry count in the first state retry unit 9 is set to ‘1’.

When the bus error signal BEC is activated, the state retry count is ‘0’, and when the output signal SO is inactive, the instruction fetch unit 16 re-issues an instruction fetch request. At this time, when the output signal SO is activated, re-issuance of an instruction fetch request is carried out after the output signal SO becomes inactive.

When the state retry count of the first state retry unit 9 is ‘1’ and a bus error occurs, the decode unit 1 converts an instruction code output from the instruction fetch unit 16 to a NOP instruction (instruction to operate nothing).

The instruction fetch unit 16 sets ‘0’ to the state retry count after re-issuance of an instruction fetch request is completed, and then returns to normal operation.

In this case, each unit operates independently. When a bus error has not occurred, the instruction fetch unit 16 fetches instructions to be executed one after another, and the decode unit 1, the execution unit 2, and the load/store unit 3 respectively execute the fetched instructions one after another, as the entire operation of the microprocessor 100. When a bus error occurs, a re-fetch operation is carried out.

The output signal SO is described forthwith. When re-issuing a fetch request, the decode unit 1, the execution unit 2, and the load/store unit 3 may retain an instruction yet to be executed. At this time, if a fetch request is re-issued without waiting for the decode unit 1, the execution unit 2, and the load/store unit 3 to complete execution of an instruction, the re-issued fetch request and a bus request, due to a load/store instruction, may exist in the bus interface unit 4 at the same time. Such an event makes re-fetching meaningless because when a bus error occurs again due to a load/store instruction, re-fetching is then sacrificed, which may cause a deadlock in which fetching is impossible. The output signal SO is provided so as to avoid such a situation.

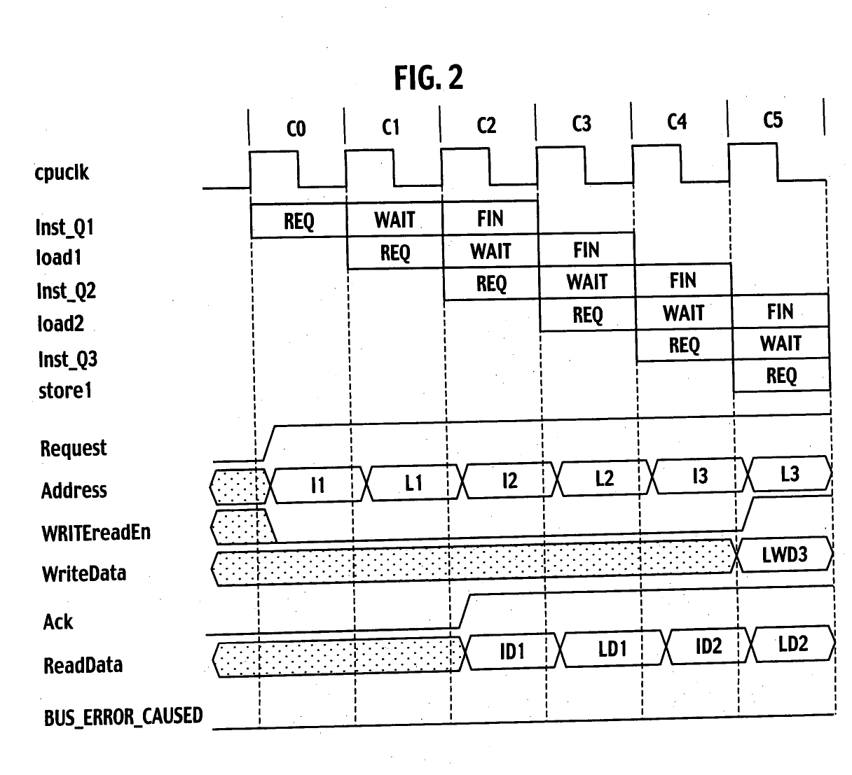

How the bus interface unit 4 in the microprocessor 100, according to the first embodiment of the present invention, operates when no bus error occurs is as shown in a timing chart of FIG. 2. In FIG. 2, Inst_Q1, Inst_Q2, Inst_Q3, load1, load2, and store1 denote respective bus request signals processed by the bus interface unit 4. Inst_Q1, Inst_Q2, and Inst_Q3 denote respective bus request signals corresponding to respective queue numbers Q1, Q2, and Q3 of the fetch request queue. The bus request signals load1, load2, and store1 denote respective due to load/store instructions.

The bus request signals BRS denote a group of signals: Request, Address, WRITEreadEn, WriteData, Ack, ReadData, and BUS_ERROR_CAUSED.

The Request signal is activated when the bus interface unit 4 needs to issue a request to the bus device 5. When the Request signal is active (i.e., ‘1’), Address, WRITEreadEn, and WriteData become valid signals.

The Address signal denotes a memory address signal.

The WRITEreadEn signal denotes a write-in request signal when active (i.e., ‘1’) and a read-out request signal when inactive (i.e., ‘0’).

The WriteData signal denotes a write-in data signal when requesting write-in.

Note that the signal BUS_ERROR_CAUSED is the same as the signal BEC in FIG. 1.

REQ, WAIT, and FIN denote internal states of the bus interface unit 4 indicating the state in which a bus request is processed by the bus interface unit 4.

REQ denotes a state in which a bus request is output to the external bus 200, making the Request signal active (i.e., ‘1’).

WAIT denotes a state of waiting for the Ack signal to become active.

FIN denotes a state of indicating that a bus request is completed. When the Ack signal is active, processing enters this state.

FIG. 2 shows a case where no bus error occurs. In this case, the bus request signals Inst_Q1, Inst_Q2, Inst_Q3, load1, load2, and store1 are processed consecutively.

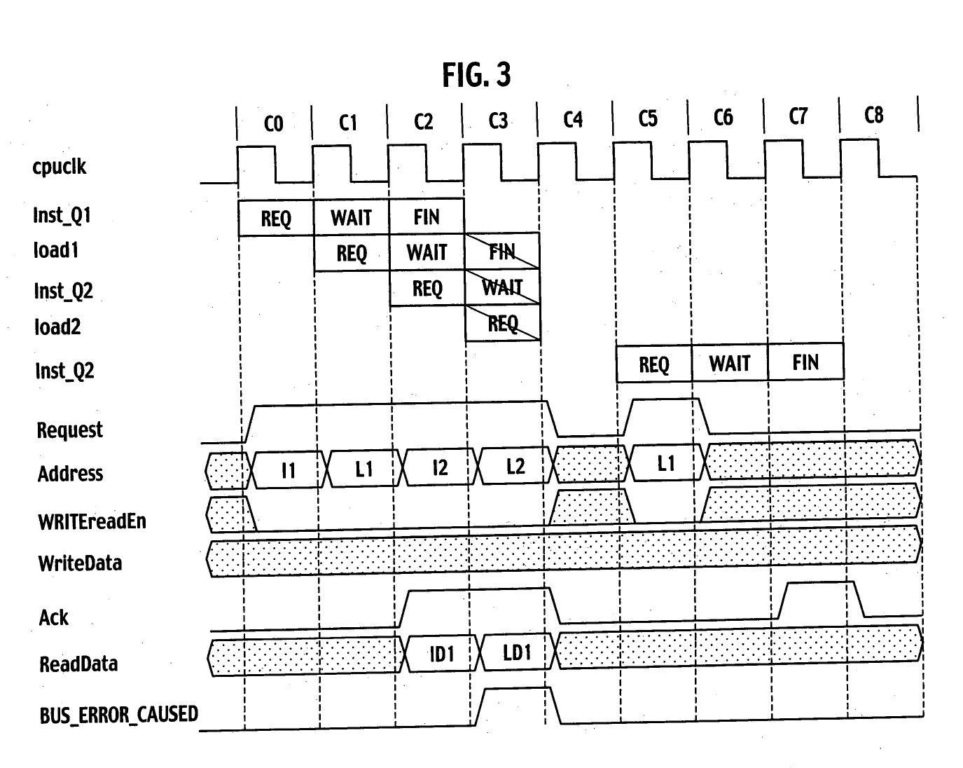

In the microprocessor 100 according to the first embodiment of the present invention, the bus interface unit 4 operates as shown in a timing chart of FIG. 3 when a bus error occurs during a clock cycle C3 in FIG. 2.

The bus interface unit 4 processes for three bus request signals: load1, Inst_Q2, and load2 during a clock cycle C3 in FIG. 3. At this time, the bus error signal BUS_ERROR_CAUSED is implemented as an asynchronous assertion of a bus error. Accordingly, in the clock cycle C3, the bus interface unit 4 discards the three requests being processed.

After discarding the three requests, processing for the bus request signal Inst_Q2 starts at a clock cycle C5.

When the bus error signal BUS_ERROR_CAUSED is active during a clock cycle C7 in FIG. 3, this means that a bus error has occurred while re-processing. In this case, as described earlier, the decode unit 1 converts a fetched instruction to the NOP instruction, which operates nothing.

The decode unit 1 makes a target fetched instruction invalid and converts the target fetched instruction to the NOP instruction.

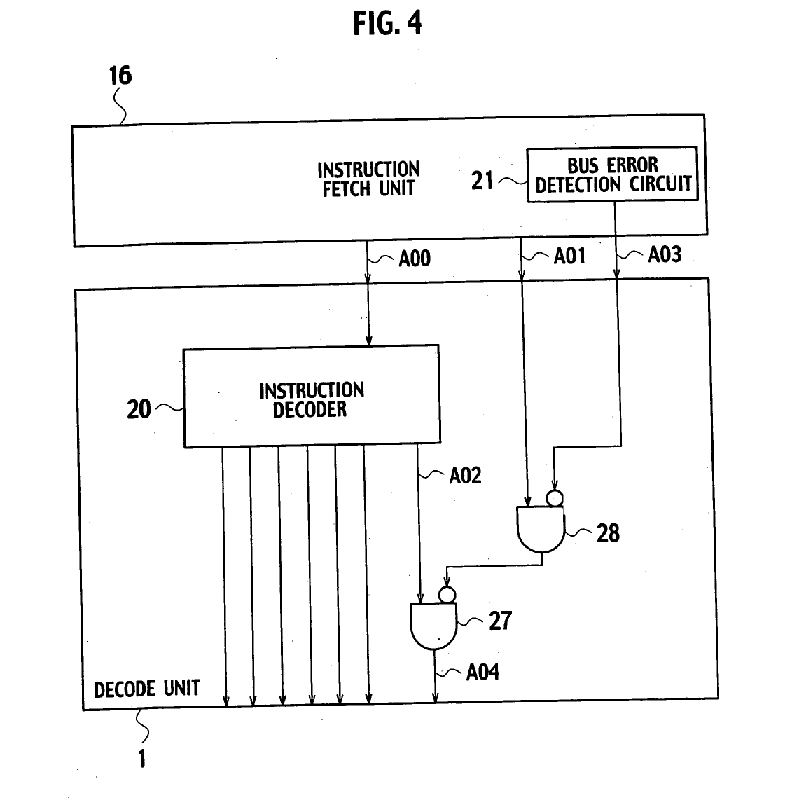

A schematic block structure of the decode unit 1 and the instruction fetch unit 16 in the microprocessor according to the first embodiment of the present invention is shown in FIG. 4.

A bus error detection circuit 21 is arranged in the instruction fetch unit 16. The bus error detection circuit 21 detects the occurrence of a bus error due to re-issuance of an instruction fetch request. Upon detection of the bus error, a signal A03 become active (i.e., ‘1’).

The instruction fetch unit 16 outputs instruction code signals A00, A01, and A02 to the decode unit 1.

The signal A00 enters an instruction decoder 20 of the decode unit 1. The signals A01 and A02 enter an AND gate with an active low input terminal 28 of the decode unit 1. The signal A01 indicates whether or not an instruction code output from the instruction fetch unit 16 is valid. When the instruction code is valid, a logic value ‘1’ is output, while when the instruction code is invalid, a logic value ‘0’ is output.

The instruction decoder 20 is a circuit for decoding instructions. The signal A02 indicates whether or not an instruction code is valid. The signal A02 is given based on the results of decoding the instruction. If the instruction code valid, the signal is a logic signal ‘1’, while if the instruction code invalid, the signal is a logic signal ‘0’. The signal A02 and an output signal of the AND gate with an active low input terminal 28 enter an AND gate with an active low input terminal 27 of the decode unit 1.

The signal A04 indicates whether or not to execute a decoded instruction. When the signal A04 is active (i.e., ‘1’), the execution unit 2 connected to the decode unit 1 executes the instruction.

When the signal A03 is active, the signal A04 becomes inactive (i.e., ‘0’). Accordingly, the execution unit 2 connected to the decode unit 1 does not execute the instruction.

The structure of the decode unit 1 in FIG. 4 converts an instruction to an operation that is equivalent to the NOP instruction, without a circuit for converting the signal A00 to ‘0 (zero)’.

According to the microprocessor of the first embodiment of the present invention, when a bus error occurs, a bus request is issued again, and if recovery is impossible, an instruction is converted to the NOP instruction, which is then executed. In such a manner, the microprocessor itself can re-issue a fetch request when using the bus.

The microprocessor of the first embodiment of the present invention is capable of re-issuing a fetch request so as to prevent occurrence of a problem in which an undefined instruction may be executed in a task in which a bus error has occurred while executing multiple tasks. Upon such occurrence, the processing will stop, thereby making it impossible to switch over to other tasks or an operating system and eventually leading to a deadlock of all tasks. The problem arises from using a small circuit scale bus that is incapable of identifying the cause of a bus error.

In addition, the microprocessor of the first embodiment of the present invention is capable of preventing all tasks from stopping because of a failure of re-fetching. Thus, the microprocessor executes an undefined instruction, by re-issuing a bus request in response to the occurrence of a bus error, converts the instruction to the NOP instruction and then executes the resulting NOP instruction if recovery is impossible.

Moreover, the microprocessor of the first embodiment is capable of converting the instruction to the NOP instruction and then executing the instruction when a bus error occurs, even though re-fetching is carried out, regarding the instruction as invalid.

The microprocessor is capable of re-issuing bus requests, due to instruction fetches, out of the bus requests being issued to the bus when a bus error is detected. A bus that allows all bus requests being presently processed to be discarded when a bus error occurs, but does not allow re-issuing a request, may be used as the bus of the microprocessor. For example, use of a bus that accepts an asynchronously asserted bus error, but does not include a circuit required for re-issuing a request, is possible. Since such a bus is of a small circuit scale and the structure thereof is simple, the time required for design and verification is short.

Moreover, the microprocessor is capable of converting a fetched instruction code to the NOP instruction when a re-issued request has caused a bus error. Once the bus error has occurred, a bus in which transmitted data value becomes indeterminate may be used as a bus for the microprocessor. Furthermore, in the case where a bus error occurs, the transmitted data need not be set to a constant value, for example, 0 (zero).

The microprocessor has a circuit for making the results of decoding an instruction invalid, instead of a circuit for converting an instruction code to the NOP instruction code before decoding. By replacing an operation for the NOP instruction with an equivalent operation, it is easy to implement a conversion of mistaken instruction codes to the NOP instructions themselves before decoding an instruction. However, since instruction decoding circuits of respective microprocessors are generally complex, particularly embedding a circuit before the instruction decoding circuits often brings about a decrease in microprocessor operating speed. As such, a circuit for executing an instruction as an operation equivalent to the NOP instruction is embedded after instruction decoding, thereby preventing a decrease in microprocessor operating speed.

According to the microprocessor of the first embodiment of the present invention, use of a small circuit scale bus allows a simple microprocessor structure, a shorter time for design and verification, and prevention of a decrease in operating speed. Moreover, protecting tasks that are not the cause of a bus error during execution of multiple tasks is possible.

### Second Embodiment

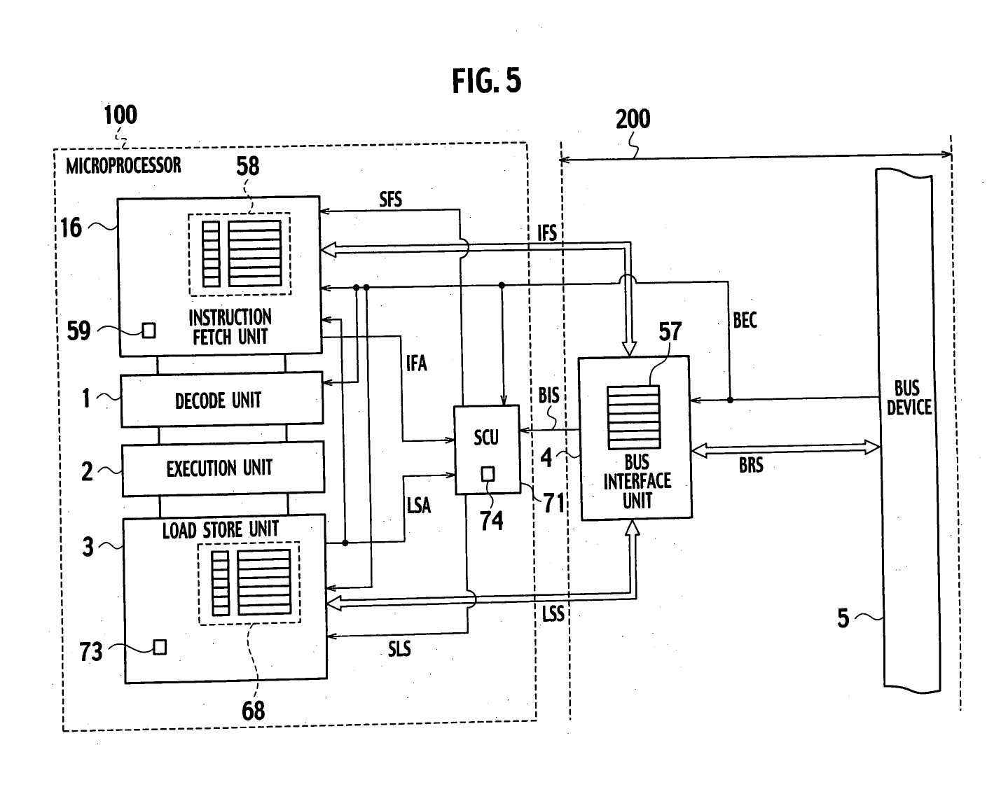

As shown in FIG. 5, a microprocessor 100 according to a second embodiment of the present invention is connectable to an external bus 200 including a bus interface unit 4 and a bus device 5. The microprocessor 100 includes an instruction fetch unit 16 having a second request queue 58 that issues, to the bus interface unit 4, a bus request for an instruction fetch and stores task numbers for identifying respective tasks in which respective bus requests are being processed. A load/store unit 3 is configured to request a bus request for a load instruction or a store instruction to the bus interface unit 4 and includes a memory 68 that stores task numbers for identifying respective tasks in which respective bus requests are being processed. A decode unit 1 is configured to decode an instruction from the instruction fetch unit 16. An execution unit 2 is configured to execute an instruction from the decode unit 1. A serialization control unit (SCU) 71 is configured to include a second state retry unit 74, which enters a re-processing mode when a bus error signal BEC received from the bus device 5 becomes active, outputs an active serialization load/store signal SLS to the load/store unit 3 and an active serialization fetch signal SFS to the instruction fetch unit 16 when a bus interface signal BIS, from the bus interface unit 4, is active in a re-processing mode.

Alternatively, in the microprocessor according to the second embodiment of the present invention, the load/store unit may reissue a request existing in the memory 68 to the bus interface unit 4, and may include a third state retry unit 73 that retains information that re-issuance of the request existing in the memory 68 has been conducted, as shown in FIG. 5.

According to the second embodiment of the present invention, elements including the bus device 5 and the bus interface unit 4 define the external bus 200. Elements comprising the instruction fetch unit 16, the decode unit 1, the execution unit 2, the load/store unit 3, and the serialization control unit 71 define the microprocessor 100.

A bus error signal BEC is used for asynchronous assertion of a bus error. The Bus device 5 transfers data. When a bus error occurs, the bus error signal BEC becomes active. The instruction fetch unit 16 issues a bus request to the bus interface unit 4 via a bus request signal IFS, due to instruction fetch in the microprocessor 100.

The load/store unit 3 issues a bus request to the bus interface unit 4 via a bus request signal LSS, due to a load instruction or a store instruction of the microprocessor 100.

The bus interface unit 4 receives and transmits a bus request issued from the microprocessor 100 from/to the bus device 5 via a bus request signal BRS. The bus interface unit 4 includes a processing queue 57 configured to retain requests from the microprocessor 100 Once the bus error signal BEC becomes active, the bus interface unit 4 determines that indeterminate data has already been read out and then terminates processing for corresponding bus requests retained in the processing queue 57. When the bus request is for reading out, the indeterminate data is returned to a requesting source, closing the session based on a predetermined protocol.

The decode unit 1 decodes instructions according to the microprocessor 100.

The execution unit 2 executes instructions according to the microprocessor 100.

The load/store unit 3 receives and transmits a bus request for a load instruction or a store instruction from/to the bus interface unit 4 via the bus request signal LSS. When the load/store unit 3 includes a bus request to be received or transmitted from/to the bus interface unit 4, a load/store signal LSA becomes active.

The instruction fetch unit 16 manages instruction fetch requests according to the microprocessor 100. The instruction fetch unit 16 issues an instruction fetch request to the bus interface unit 4 so as to fetch an instruction to be executed by the microprocessor 100. The instruction fetch unit 16 includes a second request queue 58 configured to retain requests for which corresponding results have not been provided (i.e., unprocessed requests) of the instruction fetch requests issued to the bus interface unit 4. An instruction fetch signal IFA is activated when re-processing by the instruction fetch unit 16 is completed.

The instruction fetch unit 16 is capable of re-issuing an instruction fetch request, existing in the request queue, to the bus interface unit 4. The instruction fetch unit 16 includes a state retry unit (STATE_RETRY0) 59 configured to retain information that re-issuance of an instruction fetch request has been carried out. When the re-issuance of an instruction fetch request is carried out, a state retry count (STATE_RETRY) of the state retry unit 59 is set to ‘1’. When the bus error signal BEC is activated and the state retry count is ‘0’, the instruction fetch unit 16 re-issues an instruction fetch request.

When the state retry count in the state retry unit 59 is ‘1’ and a bus error occurs, the decode unit 1 converts an instruction code output from the instruction fetch unit 16 to the NOP instruction.

The instruction fetch unit 16 sets ‘0’ to the state retry count (STATE_RETRY) when re-issuance of an instruction fetch request is completed and then returns to own normal operations.

Each unit operates independently. When a bus error has not yet occurred, the instruction fetch unit 16 fetches instructions to be executed one after another, and accordingly, the decode unit 1, the execution unit 2, and the load/store unit 3 execute the instructions one after another, as an operation of the microprocessor 100. When a bus error occurs, re-fetching starts.

The second request queue 58 in the instruction fetch unit 16 is expanded to store task numbers, which correlate bus requests to the respective tasks being presently executed by the microprocessor 100, and corresponding respective bus requests.

Memory 68, which stores bus requests for load and store instructions and corresponding respective task numbers, which correlate bus requests to respective tasks, is provided in the load/store unit 3.

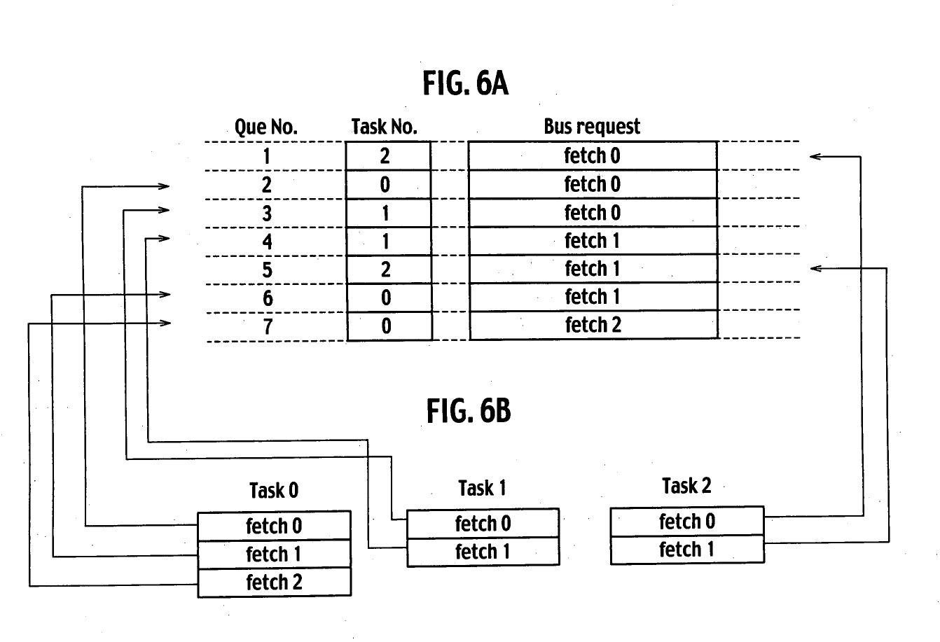

With the microprocessor 100 according to the second embodiment of the present invention, bus requests retained in the second request queue 58 of the instruction fetch unit 16 are shown in FIG. 6A and FIG. 6B. FIG. 6A schematically shows issuance of bus requests to the bus interface unit in decreasing order of queue number (Que No). FIG. 6B schematically shows tasks being presently executed: Task0, Task1, and Task2 and bus requests fetch0, fetch1, fetch2 required for instruction fetches for respective retained tasks corresponding to task identification numbers.

It is assumed here that there are three tasks being presently executed by the microprocessor 100: Task0, Task1, and Task2. In this case, bus requests: fetch0, fetch1, and fetch2 required for instruction fetches for respective tasks are retained, corresponding to task identification numbers, as shown in FIG. 6B. Seven (7) bus requests can be stored. Issuance of bus requests to the bus interface unit 4 is conducted in decreasing order of queue number, as shown in FIG. 6A.

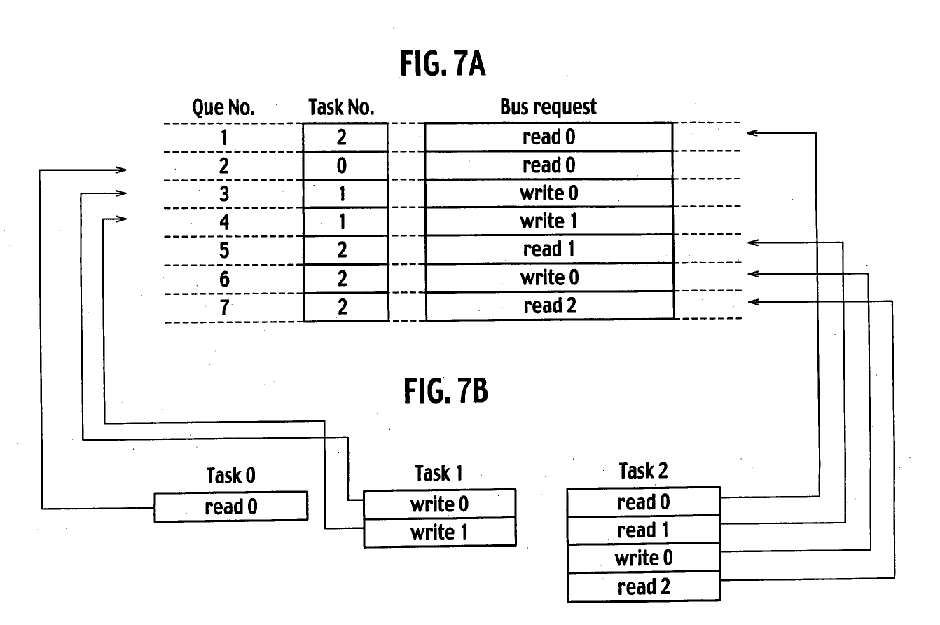

Similarly, with the microprocessor 100 according to the second embodiment of the present invention, the bus requests retained in the memory 68 of the load/store unit 3 are shown in FIG. 7A and FIG. 7B. FIG. 7A schematically shows issuance of bus requests to the bus interface unit in decreasing order of queue number. FIG. 7B schematically shows tasks being presently executed: Task0, Task1, and Task2 and bus requests read0, read1 and write0, write1 for load instructions and store instructions to be executed in the retained, respective, tasks corresponding to task identification numbers.

Bus requests read0, read1, and write0, write1 for load instructions and store instructions to be executed in respective tasks and the corresponding task identification numbers are retained in the memory 68. A storable number of requests is seven. Issuance of bus requests to the bus interface unit 4 is conducted in decreasing order of queue number.

With the microprocessor 100 according to the second embodiment of the present invention, as compared to the first embodiment, a serialization control unit 71 is added, and a serialization fetch signal SFS, a serialization load/store signal SLS, and a bus interface signal BIS are also added, as shown in FIG. 5. Moreover, the operation of the serialization control unit 71 allows ‘conversion of single bus request issuance to successive bus request issuance’.

The bus interface signal BIS is active when the bus interface unit 4 is processing a bus request.

The serialization control unit 71 sets ‘1’ to the second state retry (STATE_RETRY2) unit 74 and enters a re-processing mode when the bus error signal BEC is active. In the re-processing mode, the following operation is performed.

When the bus interface signal BIS is active, the serialization fetch signal SFS, and the serialization load/store signal SLS should also be active. When the bus interface signal BIS is inactive, either the serialization fetch signal SFS or the serialization load/store signal SLS should be inactive. At this time, a signal other than the last inactive signal becomes inactive. Accordingly, a bus request from the instruction fetch unit 16 and a bus request from the load/store unit 3 are alternately processed by the bus interface unit 4.

The serialization control unit 71 always issues an inactive serialization fetch signal SFS and an inactive serialization load/store signal SLS when not in the re-processing mode.

The instruction fetch unit 16 never issues a bus request to the bus interface unit 4 when the serialization fetch signal SFS is active.

The load/store unit 3 never issues a bus request to the bus interface unit 4 when the serialization load/store signal SLS is active. Accordingly, when in the re-processing mode, bus requests are issued to the bus interface unit 4 one at a time. As a result, even when a bus error occurs in the re-processing mode, identifying a bus request that caused the bus error to occur is possible. In summary, when multiple bus requests are issued, identifying a bus request that caused a bus error is impossible, based on asynchronous assertion of a bus error. However, processing the bus requests one by one allows identification of the cause of the bus error.

Once the instruction fetch unit 16 starts re-processing, ‘1’ is set to the state retry unit (STATE_RETRY0) 59. Once the re-processing is completed, ‘0’ is then set thereto. The load/store unit 3 sets ‘1’ to the third state retry unit (STATE_RETRY1) 73 when the bus error signal BEC becomes active, starting re-processing.

Note that the microprocessor 100 according to the second embodiment of the present invention does not include the OR gate 10 of the first embodiment, as,shown in FIG. 5. Accordingly, the instruction fetch unit 16 starts re-processing as soon as the bus error signal BEC becomes active.

When a bus error occurs in the re-processing mode and it emanates from a bus request issued by the instruction fetch unit 16 (bus request due to instruction fetch), the other bus requests with the same task number n as that for the bus request are deleted from the memory 68 in the load/store unit 3. Such deletion is possible because when at least one bus error occurs, execution of the corresponding task can never be assured, and thus there is no problem with the deletion.

When a bus error occurs in the re-processing mode and emanates from a bus request issued by the load/store unit 3 (bus request due to a load instruction or a store instruction), the other bus requests with the same task number n as that for the bus request are deleted from the memory 68 in the load/store unit 3.

When there is no further bus request to be re-processed, processing returns to the normal operation mode from the re-processing mode. The instruction fetch signal IFA becomes active when re-processing by the instruction fetch unit 16 is completed. The load/store signal LSA becomes active when re-processing by the load/store unit 3 is completed.

Note that the instruction fetch unit 16 starts a normal operation after both the instruction fetch signal IFA and the load/store signal LSA have become active. It is also noted that the second state retry unit (STATE_RETRY2) 74 in the serialization control unit 71 is a part of the microprocessor 100.

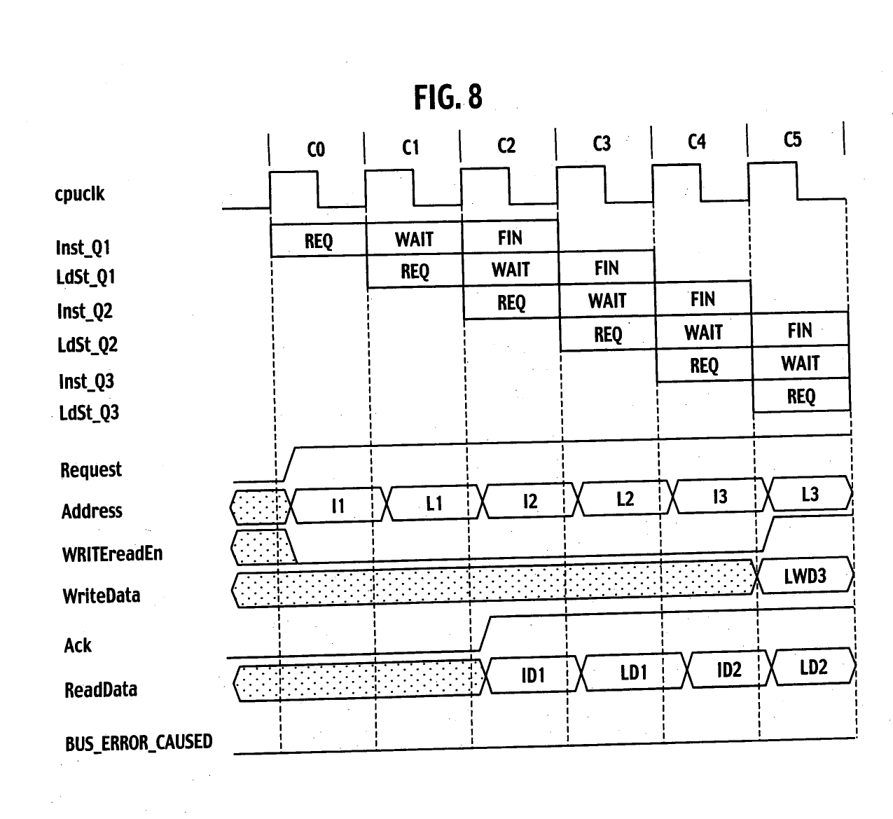

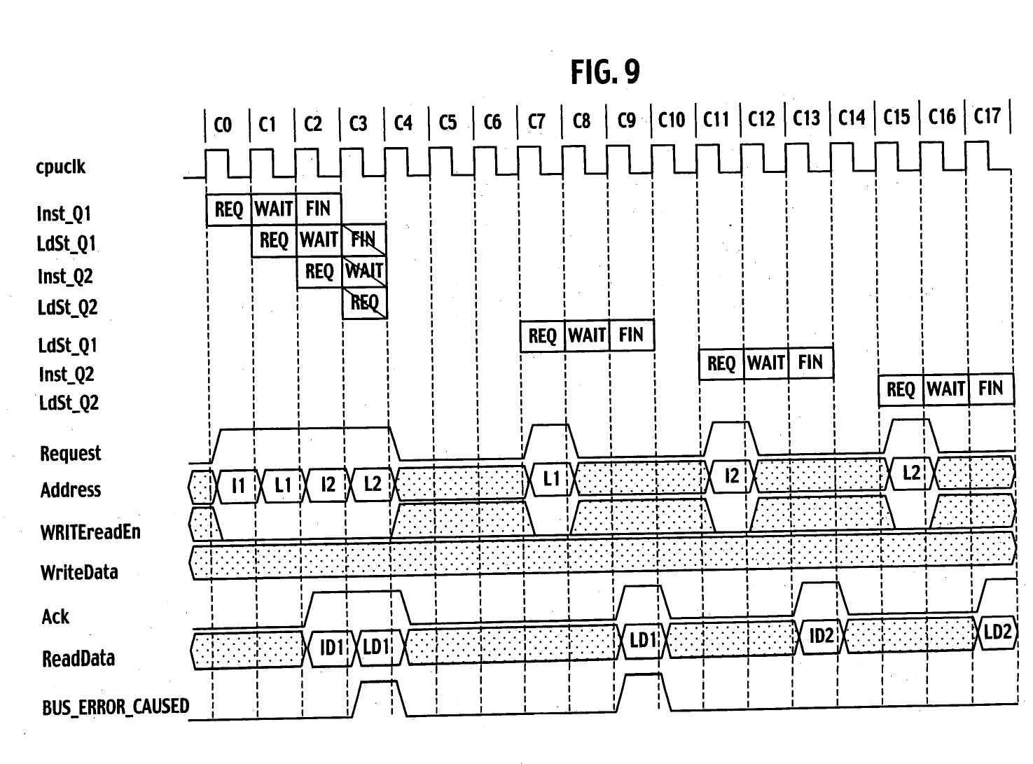

FIGS. 8 and 9 show the order that the bus requests shown in FIG. 6A, FIG. 6B, FIG. 7A and FIG. 7B are output to the bus interface unit when bus requests with the same task number are deleted.

FIG. 8 shows processing by the bus interface unit 57 and the operation of the bus request signals BRS in the case where the second request queue 58 in the instruction fetch unit and the memory 68 in the load/store unit 3 include the requests shown in FIG. 6A, FIG. 6B, FIG. 7A and FIG. 7B, respectively.

In FIG. 8, Inst_Q1, Inst_Q2, . . . and LdSt_Q1, LdSt_Q2, . . . denote respective bus requests being processed by the bus interface unit.

Inst_Q1, Inst_Q2, . . . denote respective bus requests in the fetch request queues Q1, Q2, and Q3.

LdSt_Q1, LdSt_Q2, . . . denote respective bus requests in the load/store request queues Q1, Q2, . . . .

Request, Address, WRITEreadEn, WriteData, Ack, ReadData, and BUS_ERROR_CAUSED denote signals transferred between the bus interface unit 4 and the bus device 5.

The signal Request is active when there is a request to be issued by the bus interface unit 4 to the bus device 5.

When the signal Request is active (i.e., ‘1’) the signals Address, WRITEreadEn, and WriteData are valid signals. The signal Address denotes an address in the memory. The signal WRITEreadEn denotes a write-in request when the signal is active (i.e., ‘1’). In contrast, the signal WRITEreadEn denotes a read-out request when the signal is inactive (i.e. , ‘0’). The signal WriteData denotes write-in data for the write-in request. The signal BUS_ERROR_CAUSED denotes the same as the signal BEC in FIG. 5.

REQ, WAIT, and FIN indicate in which processing state a bus request is being presently processed by the bus interface unit 4. REQ denotes a state of a bus request being output to the external bus 200. Activating the signal Request initiates the issuance of a request to the external bus 200. The request is terminated upon receipt of the signal Ack from the external bus 200.

WAIT denotes the time until the signal Ack is made active. FIN denotes that the signal Ack is active and the bus request is thus terminated.

FIG. 8 is a timing chart showing an operation by the bus interface unit 4 of the microprocessor 100 according to the second embodiment of the present invention when no bus error occurs.

In FIG. 8, Inst_Q1, Inst_Q2, Inst_Q3, LdSt_Q1, LdSt_Q2, and LdSt_Q3 denote bus request signals being presently processed by the bus interface unit 4. Inst_Q1, Inst_Q2, and Inst_Q3 denote respective bus request signals in the fetch request queues Q1, Q2, and Q3. LdSt_Q1, LdSt_Q2, and LdSt_Q3 denote respective bus request signals emanating from load/store instructions.

The bus request signals BRS includes a group of signals: Request, Address, WRITEreadEn, WriteData, Ack, ReadData, and BUS_ERROR_CAUSED.

The Request signal becomes active when the bus interface unit 4 has a request to be issued to the bus device 5. When the Request signal is active (i.e., ‘1’), the signals Address, WRITEreadEn, and WriteData are valid signals.

The Address signal denotes an address signal for the memory.

The WRITEreadEn signal, when it is active (i.e. , ‘1’) , denotes a write-in request signal. In contrast, the signal denotes a read-out request signal when it is inactive (i.e., ‘0’).

The WriteData signal denotes a write-in data signal for a write-in request.

The signal BUS_ERROR_CAUSED is the same as the BEC in FIG. 5.

REQ, WAIT, and FIN denote an internal state of the bus interface unit 4, showing the processing state in which a bus request is being presently processed by the interface unit 4.

REQ denotes a state of a bus request being output to the external bus 200, causing the Request signal to become active (i.e., ‘1’).

WAIT denotes a state of waiting for the Ack signal to become active.

FIN indicates that a bus request is terminated. An active Ack signal indicates a FIN state.

In FIG. 8, there is no bus error. Accordingly, the bus request signals: Inst_Q1, Inst_Q2, Inst_Q3, LdSt_Q1, LdSt_Q2, and LdSt_Q3 are consecutively processed.

FIG. 9 is a timing chart showing an operation of the bus interface unit 4 of the microprocessor 100 according to the second embodiment of the present invention when a bus error occurs during a clock cycle C3 FIG. 8.

The bus error signal BUS_ERROR_CAUSED is asserted, indicating occurrence of a bus error during the clock cycle C3. The bus interface unit 4 processes three requests: LdSt_Q1, Inst_Q2, and LdSt_Q2 during the clock cycle C3. Note that the bus error signal BUS_ERROR_CAUSED is asynchronously asserted, indicating a bus error. Accordingly, the bus interface unit 4 discards those three requests being presently processed during the clock cycle C3.

After discarding the requests being presently processed, the bus interface unit 4 re-processes from a clock cycle C7 to the bus request in conformity with the aforementioned procedure. Issuance of requests to the bus interface unit 4 is carried out one by one while re-processing. Such processing on a one-by-one basis allows identification of the cause of a bus error.

First, of the discarded bus requests, the oldest request LdSt_Q1 is issued during the clock cycle C7. Afterwards, the bus error signal BUS_ERROR_CAUSED is asserted during a clock cycle C9. Accordingly, the bus request LdSt_Q1 proves to be the cause of the bus error during the clock cycle C3. Referencing FIG. 7A and FIG. 7B, the bus request of Q1 is a bus request for Task No.2. Accordingly, the load/store unit 3 deletes queue numbers Q1, Q5, Q6, and Q7 shown in FIG. 7A and FIG. 7B from the request queue.

According to the microprocessor of the second embodiment of the present invention, when a bus error occurs, re-issuance of a bus request is carried out. If recovery is impossible, the instruction is converted to the NOP instruction and then executed. Use of the bus allows the microprocessor itself to re-issue a fetch request.

The microprocessor according to the second embodiment of he present invention uses a small circuit scale bus and is capable of temporary using the bus. Such procedure permits asynchronous assertion of a bus error as a synchronous assertion method for a bus error, so as to prevent execution of other tasks from being sacrificed and broken down by a task in which a bus error has occurred while executing multiple tasks.

Furthermore, the microprocessor according to the second embodiment of the present invention regards the instruction as an invalid instruction when a bus error occurs, even though re-fetching is carried out, and converts the instruction to the NOP instruction, which is then executed.

The microprocessor is capable of re-issuing only a bus request from an instruction fetch when a bus error occurs. Thus, even a bus allowing all the bus requests being processed to be discarded and not allowing re-issuance of a request when a bus error occurs, may be used as the bus for the microprocessor. For example, a bus not including a circuit required for re-issuing a request and allowing asynchronous assertion of a bus error may be used. Since such a bus may be of a small circuit scale and simply structured, the time for design and verification may be short.

Furthermore, the microprocessor capable of converting a fetched instruction code to the NOP instruction when re-issuance of a request has caused a bus error. Thus, a bus providing an indeterminate transferred data value when a bus error occurs may be used as the bus for the microprocessor. Moreover, when a bus error occurs, setting a constant value, for example, 0 (zero) to transferred data is unnecessary.

Furthermore, the microprocessor may include a circuit for making results of instruction decoding invalid and replacing the operation with an operation equivalent to the NOP instruction, instead of a circuit for converting an instruction code to the NOP instruction code before instruction decoding. Thus, a method of converting an instruction code itself before instruction decoding may be easily implemented for converting a false instruction code to the NOP instruction. However, since the instruction decoding circuit of the microprocessor generally has a complex structure, embedding a circuit before the decoding circuit may particularly cause a decrease in operating speed of the microprocessor. Therefore, a circuit executing an instruction as the NOP instruction may be embedded after instruction decoding. Such a structure will prevent decrease in operating speed of the microprocessor.

Furthermore, since the microprocessor according to the second embodiment of the present invention is capable of re-issuing a bus request when a bus error occurs, and not issuing the next bus request during the re-issuance until processing for the previous bus request is completed, protecting tasks by identifying the cause of a bus error is possible.

Furthermore, the microprocessor according to the second embodiment of the present invention is capable of retaining bus requests being issued to the bus and corresponding task numbers, and deleting, a bus request unnecessary for executing tasks. Since it is unnecessary to protect discardable tasks, deletion of bus requests emanating from those tasks for re-processing increases the operating speed when a bus error occurs.

The microprocessor of the second embodiment of the present invention uses a small circuit scale bus and is simply structured, thereby shortening the time for design and verification, preventing a decrease in operating speed, and protecting tasks that are not the cause of a bus error during execution of multiple tasks.

### Other Embodiments

As described above, the present invention has been described according to the first and the second embodiment. However, it should not be construed that the description and drawings configuring part of this disclosure are to limit the present invention. This disclosure makes clear a variety of alternative embodiments, working examples, and operational techniques for those skilled in the art. Needless to say, the present invention includes a variety of embodiments or the like not disclosed herein. Accordingly, the technical scope of the present invention should be defined by only the appended claims that appear appropriate from the above explanation.

Various modifications will become possible for those skilled in the art after receiving the teachings of the present disclosure without departing from the scope thereof.

What is claimed is:

1. A microprocessor connectable to an external bus including a bus interface unit and a bus device; the microprocessor comprising:
an instruction fetch unit comprising a request queue that issues a bus request to the bus interface unit due to an instruction fetch and that stores an unprocessed request of instruction fetch requests issued and output to the bus interface unit;
a load/store unit configured to issue a bus request to the bus interface unit due to a load instruction or a store instruction;
a decode unit configured to decode an instruction from the instruction fetch unit;
an execution unit configured to execute an instruction from the decode unit; and
an OR gate configured to output an active pipeline-busy signal when at least one of respective signals from the decode unit, the execution unit, and the load/store unit becomes active.

2. The microprocessor of claim 1, wherein the instruction fetch unit further comprises a state retry unit configured to re-issue a fetch request existing in the request queue to the bus interface unit and retain information that the instruction fetch request has been re-issued; wherein re-issuance of the instruction fetch request causes a state retry count in the state retry unit to be set to ‘1’.

3. The microprocessor of claim 1, wherein the bus interface unit comprises a processing queue configured to retain a bus request from the microprocessor and output and receive a bus request signal to/from the bus device.

4. The microprocessor of claim 2, wherein the decode unit either converts an instruction code output from the instruction fetch unit to a NOP instruction when a state retry count in the state retry unit is ‘1’ and a bus error occurs or performs processing equivalent to the NOP instruction by making the results from decoding an instruction code issued from the instruction fetch unit invalid when a state retry count in the state retry unit is ‘1’ and a bus error occurs.

5. The microprocessor of claim 2, wherein the instruction fetch unit re-issues an instruction fetch request when a bus error occurs, a state retry count in the state retry unit is ‘0’, and the pipeline-busy signal is inactive; while the instruction fetch unit waits for the pipeline-busy signal to become inactive when the pipeline-busy signal is active and then re-issues an instruction fetch request.

6. The microprocessor of claim 2, wherein the instruction fetch unit sets ‘0’ to the state retry count in the state retry unit after re-issuance of all instruction fetch requests is completed, and then resumes normal operation.

7. The microprocessor of claim 3, wherein when a bus error signal from the bus device is active, the bus interface unit interprets such active signal as indeterminate data having been read out and terminates the bus request retained in the processing queue, and when the bus request is a read-out request, the bus interface unit returns the indeterminate data to a requesting source, and closes the session operation, based on a predetermined protocol.

8. A microprocessor connectable to an external bus including a bus interface unit and a bus device; the microprocessor comprising:
an instruction fetch unit including a request queue configured to issue a bus request, due to an instruction fetch, to the bus interface unit and retain a task number for identifying a task in which a bus request is being processed and a corresponding bus request;
a load/store unit configured to issue a bus request, due to a load instruction or a store instruction, to the bus interface unit, the load/store unit includes a memory configured to retain a task number for identifying a task in which a bus request is being processed and a corresponding bus request;
a decode unit configured to decode an instruction from the instruction fetch unit;
an execution unit configured to execute an instruction from the decode unit; and
a serialization control unit including a state retry unit configured to set ‘1’ to the state retry count in the state retry unit and enter a re-processing mode when the state retry unit receives input signals from the instruction fetch unit, the load/store unit, the bus interface unit, and the bus device and a bus error signal from the bus device becomes active, and output suppression signals for suppressing issuance of a bus request from the instruction fetch unit and the load/store unit when a bus interface signal from the bus interface unit is active in the re-processing mode.

9. The microprocessor of claim 8, wherein the load/store unit comprises another state retry unit configured to re-issue a request existing in the memory to the bus interface unit and retain information that the request existing in the memory has been re-issued; wherein re-issuance of the request existing in the memory causes a state retry count in the another state retry unit to be set to ‘1’.

10. The microprocessor of claim 8, wherein the instruction fetch unit comprises the other state retry unit configured to re-issue an instruction fetch request existing in the request queue to the bus interface unit and retain information that the instruction fetch request has been re-issued; wherein re-issuance of the instruction fetch request causes the state retry count in the other state retry unit to be set to ‘1’.

11. The microprocessor of claim 9, wherein the load/store unit re-issues a request existing in the memory when a bus error occurs and the state retry count in the another state retry unit is ‘0’.

12. The microprocessor of claim 9, wherein the load/store unit sets ‘0’ to the state retry count in the another state retry unit after re-issuance of all requests existing in the memory is completed, and then resumes normal operation.

13. The microprocessor of claim 9, wherein if a bus error occurs emanating from a bus request for loading or storing when the state retry count in the another state retry unit is ‘1’, other bus requests with the same task number as that for the bus request are deleted from the memory, and the resulting deleted bus requests are no longer re-issued.

14. The microprocessor of claim 10, wherein the decode unit either converts an instruction code issued from the instruction fetch unit to a NOP instruction when the state retry count is ‘1’ in the other state retry unit and a bus error occurs or performs processing equivalent to the NOP instruction by making the results from decoding an instruction code issued from the instruction fetch unit invalid when the state retry count in the other state retry unit is ‘1’ and a bus error occurs.

15. The microprocessor of claim 10, wherein the instruction fetch unit re-issues an instruction fetch request when a bus error occurs and the state retry count in the other state retry unit is ‘0’.

16. The microprocessor of claim 10, wherein the instruction fetch unit sets ‘0’ to the state retry count in the other state retry unit after re-issuance of all instruction fetch requests is completed, and then resumes normal operation.

17. The microprocessor of claim 10, wherein if a bus error occurs emanating from a bus request due to instruction fetch when the state retry count in the another state retry unit is ‘1’, other bus requests with the same task number as that for the bus request are deleted from the memory, and the resulting deleted bus requests are no longer re-issued.
